(19) United States
(12) Patent Application Publication
(10) Pub. No.: US 2021/0130058 A1
(43) Pub. Date: May 6, 2021

(54) WRAPPING DEVICE HAVING CORNER PROTECTORS FOR SECURING AND SUPPORTING PALLETIZED MATERIALS

(71) Applicant: HUALONG WANG, APEX, NC (US)

(72) Inventor: HUALONG WANG, APEX, NC (US)

(21) Appl. No.: 16/674,285

(22) Filed: Nov. 5, 2019

(51) Int. Cl. B65D 71/00; B65D 81/05; B65D 63/10

(52) U.S. Cl. CPC B65D 71/0088; B65D 63/1018; B65D 81/056

(57) ABSTRACT

Implementations of the present disclosure generally relate to a reusable wrapping device for securing loaded goods on a pallet. Particularly, the wrapping device according to the present disclosure including edge protectors. The wrapping device includes one or more edge protector. Each edge protector includes two edge panels joined by one edge, and a strap slidingly attached to the one or more edge protector. Each edge panel includes strap retainer to receive the strap therethrough.

### BACKGROUND

### Field

Implementations of the present disclosure generally relate device for securing and supporting goods to be transported on a transportation carrier, such as a pallet. More particularly, embodiments of the present disclosure relate to a reusable pallet wrapping assembly including edge protectors and one or more restraining straps.

### Description of the Related Art

Transportation carriers such as pallets are commonly used in the industry for moving loads for shipment. Various articles or containers are stacked on pallets to be moved from one place to another using a forklift or other mechanical device. One issue that may arise during transportation of the pallets is that the articles or containers can shift or fall that would require re-loading or even replacement of damaged articles or containers.

One solution to this issue is through the use of pallet wraps around pallets to hold the wrapped goods in position. Edge protectors are also used in addition to the wraps on edges of pallets to protect products on the pallets and prevent products from shifting horizontally during transportation. The wraps and the edge protectors are usually applied separately. The process of applying and removing the wraps and the edge protectors is labor intensive and time consuming. In addition, the edge protector can only be used once and require disposal after each use, which is not environment friendly.

Therefore, a need therefore exists for an improved, reusable device for securing goods and protecting edges in a palletized load.

### SUMMARY

Implementations of the present disclosure generally relate to wrapping devices for pallet loads. Particularly, the wrapping device according to the present disclosure including edge protectors.

One embodiment provides a wrapping device comprising one or more edge protector, wherein each edge protector comprises two edge panels joined by one edge, and a strap slidingly attached to the one or more edge protector, wherein each edge panel includes strap retainer to receive the strap therethrough.

Another embodiment provides a wrapping device comprising a first edge panel, a second edge panel, wherein the first edge and the second edge panel are joined together along one edge, and an end panel connected to the first and second edge panels at one end, wherein the first edge panel and second edge panel form a corner.

Another embodiment provides a wrapping device for securing a pallet load. The device includes four edge protectors and one or more straps slidingly connected to the four edge protectors. Each edge protector includes a first edge panel, a second edge panel, wherein the first edge and the second edge panel are joined together along one edge, and an end panel connected to the first and second edge panels at one end, wherein the first edge panel and second edge panel form a corner.

Yet another embodiment provides a method of storing a wrapping device. The method includes sequentially stacking corner protectors, wherein the corner protectors are threaded through one or more straps, and securing the stacked protectors using the one or more straps.

### BRIEF DESCRIPTION OF THE DRAWINGS

So that the manner in which the above-recited features of the present disclosure can be understood in detail, a more particular description of the implementations, briefly summarized above, may be had by reference to implementations, some of which are illustrated in the appended drawings. It is to be noted, however, that the appended drawings illustrate only typical implementations of this disclosure and are therefore not to be considered limiting of its scope, for the disclosure may admit to other equally effective implementations.

FIG. 1A is a schematic perspective view of a wrapping device according to one embodiment of the present disclosure.

FIG. 1B is a schematic perspective view of an edge protector in the wrapping device according to one embodiment of the present disclosure.

FIG. 1C is a schematic perspective view of the edge protector of FIG. 1B showing inner surfaces.

FIG. 1D is a schematic sectional view of the edge protector of FIG. 1B.

FIG. 1E is a schematic sectional view of the edge protector of FIG. 1D with a strap threaded therethrough.

FIG. 2A is a schematic perspective view of applying a wrapping device according to the present disclosure on a pallet load.

FIG. 2B is a schematic perspective view of a pallet load secured with a wrapping device according to the present disclosure.

FIG. 3A is a schematic perspective view of an edge protector according to embodiments of the present disclosure.

FIG. 3B is a perspective view of an edge protector according to embodiments of the present disclosure.

FIG. 4A-4B are schematic partial perspective views of a wrapping device according to one embodiment of the present disclosure.

FIG. 5A is a schematic partial perspective view of a wrapping device according to one embodiment of the present disclosure.

FIG. 5B is a schematic partial sectional view of the wrapping device of FIG. 5A.

FIG. 5C is a schematic partial sectional view of the wrapping device of FIG. 5A with a strap threaded therethrough.

FIG. 6A is a schematic partial perspective view of a wrapping device according to one embodiment of the present disclosure.

FIG. 6B is a schematic partial sectional view of the wrapping device of FIG. 6A.

FIG. 6C is a schematic partial sectional view of the wrapping device of FIG. 5A with a strap threaded therethrough.

FIG. 7 is a schematic partial perspective view of a wrapping device according to one embodiment of the present disclosure.

FIG. 8 is a schematic partial sectional view of a wrapping device according to one embodiment of the present disclosure.

FIGS. 9A and 9B schematically illustrate a method for storing a wrapping device according to one embodiment of the present embodiment.

FIGS. 10A and 10B schematically illustrate a method for forming a corner protector according to one embodiment of the present disclosure.

FIG. 11A schematically illustrates a removable insert for the wrapping device according to embodiments of the present disclosure.

FIG. 11B is a partial schematic view of a wrapping device with removable inserts according to embodiments of the present disclosure.

FIG. 11C is a schematic view of a pallet secured with a wrapping device with removable inserts according to embodiments of the present disclosure.

FIG. 11D is a schematic sectional view of a wrapping device with inserts showing a method of storing the wrapping device.

To facilitate understanding, identical reference numerals have been used, where possible, to designate identical elements that are common to the figures. It is contemplated that elements and features of one implementation may be beneficially incorporated in other implementations without further recitation. It is to be noted, however, that the appended drawings illustrate only exemplary implementations of this disclosure and are therefore not to be considered limiting of its scope, for the disclosure may admit to other equally effective implementations.

### DETAILED DESCRIPTION

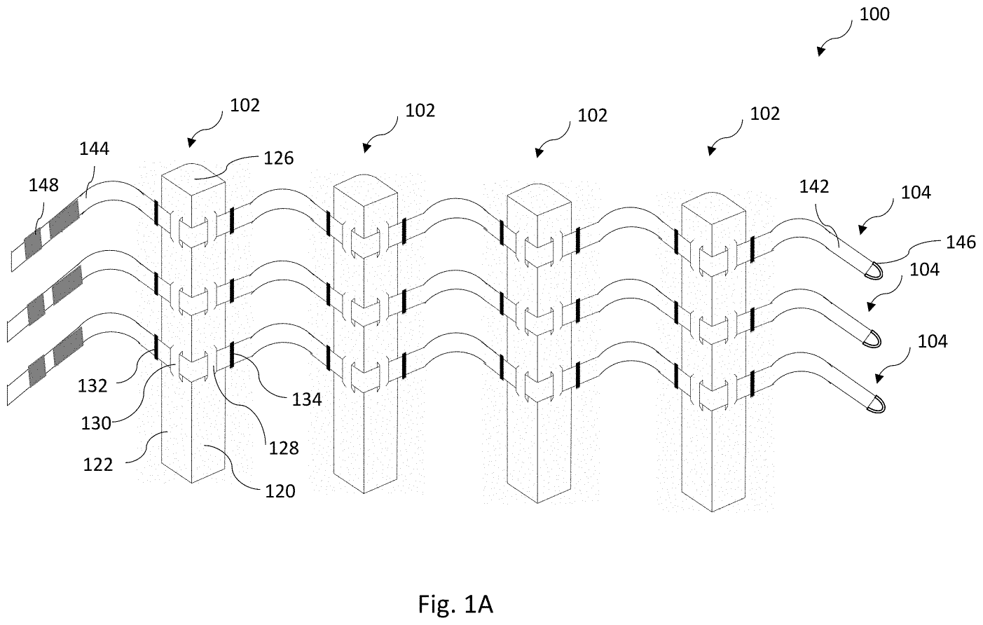

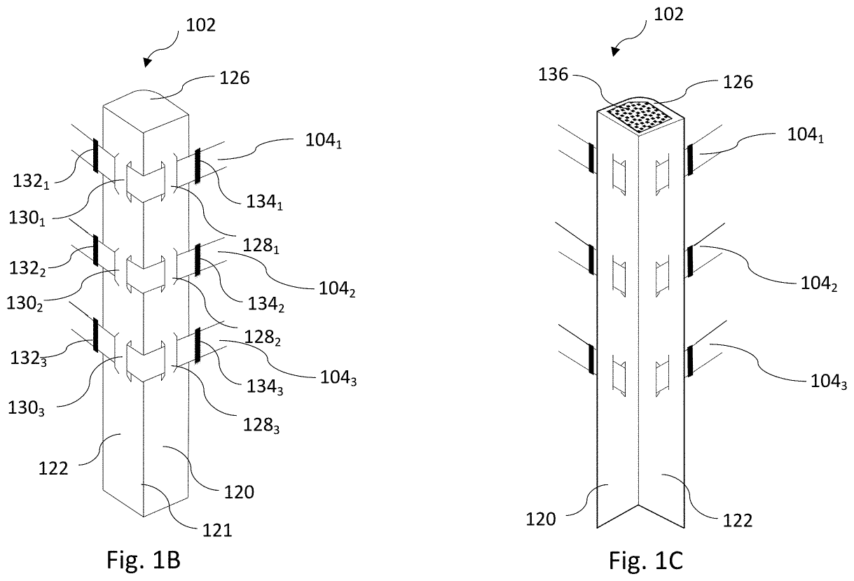

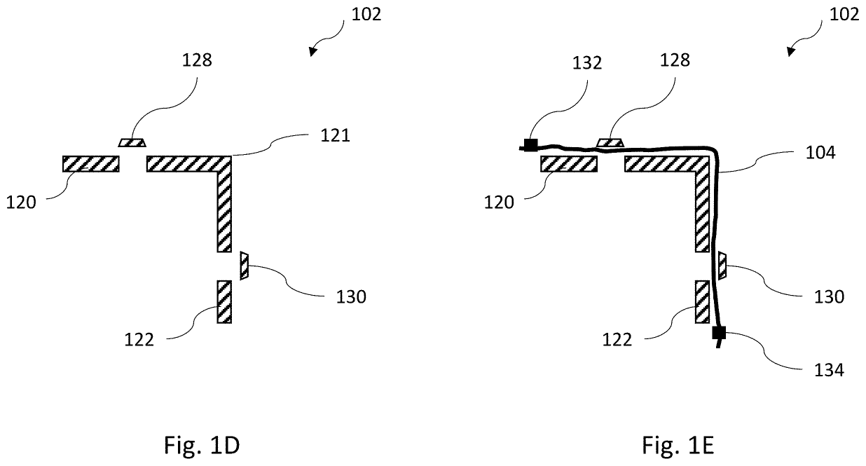

The following disclosure describes a wrapping device for securing goods on a transportation carrier such as a pallet. Details are set forth in the following description and in FIGS. 1-11 to provide a thorough understanding of various implementations of the disclosure. Many of the details, dimensions, angles and other features shown in the Figures are merely illustrative of particular implementations. Accordingly, other implementations can have other details, components, dimensions, angles and features without departing from the spirit or scope of the present disclosure. In addition, further implementations of the disclosure can be practiced without several of the details described below.

Embodiments of the present disclosure relate to a wrapping device for securing and supporting a load on a pallet during storage and transportation. More particularly, embodiments of the present disclosure provide a wrapping device including edge protectors and one or more straps threaded therethrough. Each edge protector includes two planar panels sharing an edge. The edge protector further includes an end panel connected to the two planar panels at one end. The end panel and the two planar panels form a corner shaped to conform with a corner on a pallet load. During operation, edge protectors can be positioned one by one on corners of a pallet. The end panel ensures that the edge protector stays in place. After each corner of the pallet load is covered with an edge protector, the one or more straps may be tightened up to wrap and secure the pallet load.

FIG. 1A is a schematic perspective view of a wrapping device 100 according to one embodiment of the present disclosure. The wrapping device 100 includes edge protectors 102 and one or more straps 104. In some embodiments, the wrapping device 100 includes one or more edge protectors 102. Each edge protector 102 is configured to be positioned on an edge of a pallet load. In one embodiment, the wrapping device 100 includes four edge protectors 102 for protecting four vertical edges on a rectangular prism or cubic pallet load. In other embodiments, the wrapping device 100 may include fewer or more edge protectors 102 for securing pallet loads of other shapes. Each edge protector 102 include one or more strap retainers to receive and secure the one or more straps 104. Each strap 104 is movably relative to the edge protectors 102 by sliding through the retainers. The one or more straps 104 are generally arranged parallel to each other. The number of straps 104 may be selected according to the length of edge protectors 102. As shown in FIG. 1A, each strap 104 threads through the edge protectors 102. During operation, the edge protectors 102 are first positioned one by one on edges of a pallet load. The pallet load is then secured with the wrapping device 100 by tightening and joining two ends of each straps 104.

FIG. 1B is a schematic perspective view of the edge protector 102 in the wrapping device 100 according to one embodiment of the present disclosure. FIG. 1C is a schematic perspective view of the edge protector 102 showing inner surfaces. FIG. 1D is a schematic sectional view of the edge protector 102. FIG. 1E is a schematic sectional view of the edge protector 102 showing the connection between the edge protector 102 and the strap 104.

The edge protector 102 includes a first edge panel 120 and a second edge plane 122. Each edge panel 120, 122 may be a rectangular shaped sheet material. In some embodiments, the panels 120, 122 may have identical dimensions. In other embodiments, the edge panels 120, 122 may have different shapes and/or dimensions to achieve desired functions and/or esthetic functions. In some embodiments, the edge panels 120, 122 are rectangular panels and joined at long side to form an edge 121. In some embodiments, the edge panels 120, 122 are joined at angle of about 90 degrees to conform with edges on rectangular pallet loads. Alternatively, the edge panels 120, 122 may be joined at other angles to conform with loads of other shapes.

The edge protector 102 further includes an end panel 126. The end panel 102 may be also made of sheet material. The end panel 126 are joined to both edge panels 120, 122 at short sides of the edge panels 120, 122. The edge panels 120,122 and the end panel 126 form a corner, which allows the edge protector 102 to stay on a corner of a pallet load without additional restraint. The end panel 126 may be a square shaped sheet with a round corner 126a as shown in FIGS. 1B and 1C. Alternatively, the end panel 126 may be any suitable shapes to form a structure to allow the edge panels 120, 122 to rest on pallet loads without any external support. For example, the end panel 126 may be shaped like a fan, a triangle, or other shapes.

In some embodiments, the edge protector 102 may have a high friction region 136 in an inner surface of the end panel 126 as shown in FIG. 1C. The high friction region 136 may have a high roughness or may include materials that generate high friction with pallet loads, thus, preventing the edge protector 102 from falling out of the pallet load before the straps are tightened up. In some embodiments, the high friction region 136 is formed by attaching a piece of sandpaper to the inner side of the end panel 126. In some embodiments, the high friction region 136 is formed by attaching a rubber film or plate to the inner side of the end panel 126. In some embodiments, the rubber film or plate may include protrusions. In other embodiments, the high friction region 136 may be formed by forming a high roughness area with surface valleys and protrusions, which may be formed during molding or post formation process, such a sand bombardment.

In some embodiments, the edge panels 120, 122 include strap retainers 128, 130 respectively. The strap retainers 128, 130 may form a loop structure on the edge panel 120, 122 to allow the strap 104 to be threaded therethrough and to slide relative to the edge protector 102. In some embodiments, the strap retainers 128, 130 may be strip of sheet partially cut out from the edge panels 120, 122 to form a loop, as shown in FIGS. 1B and 1C. In some embodiments, each strap retainer 128, 130 may include a strip of sheet material protruding from the edge panels 120, 122 as shown in FIG. 1D. The strap retainer 128, 130 may have a thinner thickness than the edge panels 120, 122. The strap retainers 128, 130 may be positioned symmetrically about the edge 121 on the edge panels 120, 122. FIG. 1D shows a portion of the strap 104 threading through the strap retainers 128, 130.

In some embodiments, the wrapping device 100 includes more than one straps when the edge protector 102 is long. For example, the wrapping device 100 includes straps 104₁, 104₂, 104₃. The edge protector 102 may include more than one strap retainers 128₁, 128₂, 128₃, 130₁, 130₂, 130₃ distributed along the length of the edge panels 120, 122. The multiple straps 104₁, 104₂, 104₃ are positioned parallel to each other through the edge protectors 102.

The panels 120, 122 and 126 may be made of sheet materials with suitable stiffness to provide restraint and support to the pallet load. The panels 120, 122, 126 may be formed any suitable wrapping material, such as paper cardboard, plastic board, plastic cardboard, foam, rubber, polymer. In some embodiments, the panels 120, 122, 126 are made with durable materials such that the wrapping device 100 can be reused for many times. In some embodiments, the panels 120, 122, 126 may be formed separately and then joined together with suitable process, such as by adhesives, by nesting structures, by fasteners, or other securing methods. In other embodiments, the panels 120, 122, 126 may be formed as a unitary body. The edge protector 102 may be formed from a single piece of sheet material by bending, pressing, and other processes known the people skilled in the art.

Each strap 104 may be a strip of cloth, leather, fabric or any suitable flexible material such as polyester, nylon, polypropylene, polyethylene, canvas, composite woven, any suitable natural or synthetic materials, or any combination thereof. The strap 104 may also be a non-stretching material made of any suitable composite or synthetic material.

Each strap 104 includes two ends 142, 144. When the wrap device 100 is in use, the two ends 142, 144 are joined together to tie the edge protectors 102 and the pallet load. The two ends 142, 144 may be used joined by any suitable ways. In some embodiments, the end 142 may include a connection ring 146 and the end 144 may include a hook-and-loop type fastener 148. The connection ring 146 may have a “D” shape or the like that is sized to allow the end 144 of the straps 104 to pass through and wrap around at least a portion of the pallet and loaded goods. The hook-and-loop type fastener 148 works with the connection rings 146 by permitting the hook-and-loop type fastener 148 to pass through and fold back and attach to themselves to secure the edge protectors 102 around the pallet load.

In other embodiments, the two ends 142, 144 may be joined together by clasps, similar to the tightening structure of airplane seat belts.

In some embodiments, the wrapping device 100 also include stoppers 132, 134 positioned on the strap 104 to limit the range of motion of each edge protector 102 relative to the strap 104. The stoppers 132 prevent the edge protectors 102 and the straps 104 from tangling together and enable easy operation and storage of the wrapping device 100. As shown in FIG. 1B, multiple stoppers 132₁, 132₂, 132₃, 134₁, 134₂, 134₃ may be used for multiple straps 104₁, 104₂, 104₃. In some embodiments, the stoppers 132, 134 are fixedly attached to the strap 104. In some embodiments, the stoppers 132, 134 may be removable buttons, clips, or other suitable structures can be attached to the strap 104. The stoppers 132, 134 may be removed and adjusted as needed.

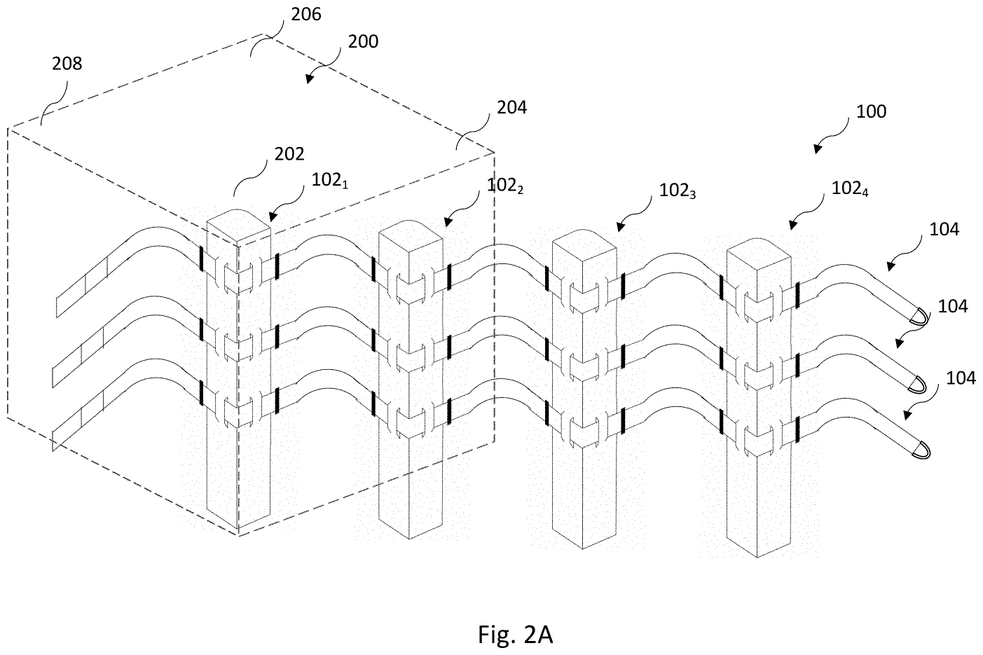

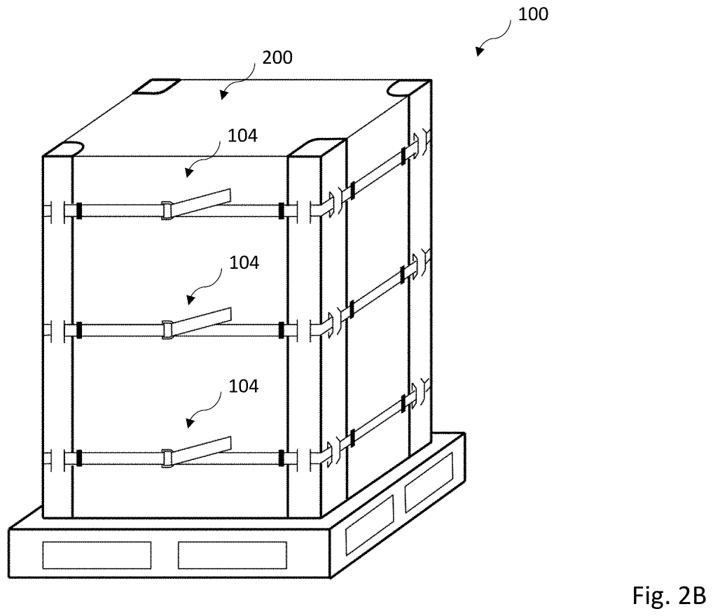

FIG. 2A is a schematic perspective view of applying the wrapping device 100 according to the present disclosure on a pallet load 200. The pallet load 200 is a rectangular load having four vertical edges. To apply the wrapping device 100 on the pallet load 200, first put the edge protectors 102₁, 102₂, 102₃, 102₄ sequentially on corners 202, 204, 206, 208 of the pallet load 200. Because the end panels 126 on the edge protectors 102₁, 102₂, 102₃, 102₄ allow the edge protectors 102₁, 102₂, 102₃, 102₄ to stay on the pallet load 200 while the straps 104 are not tied up, the wrapping device 100 can be applied by a single operator. When all four edge protectors 102₁, 102₂, 102₃, 102₄ are in place, the straps 104 may be pulled tight and opposing ends of the straps 104 tied together to secure the pallet load 200 with the wrapping device 100. FIG. 2B is a schematic perspective view of the pallet load 200 secured with a wrapping device 100 according to the present disclosure. The wrapping device 100 can be easily applied by one operator, thus, reducing operating cost.

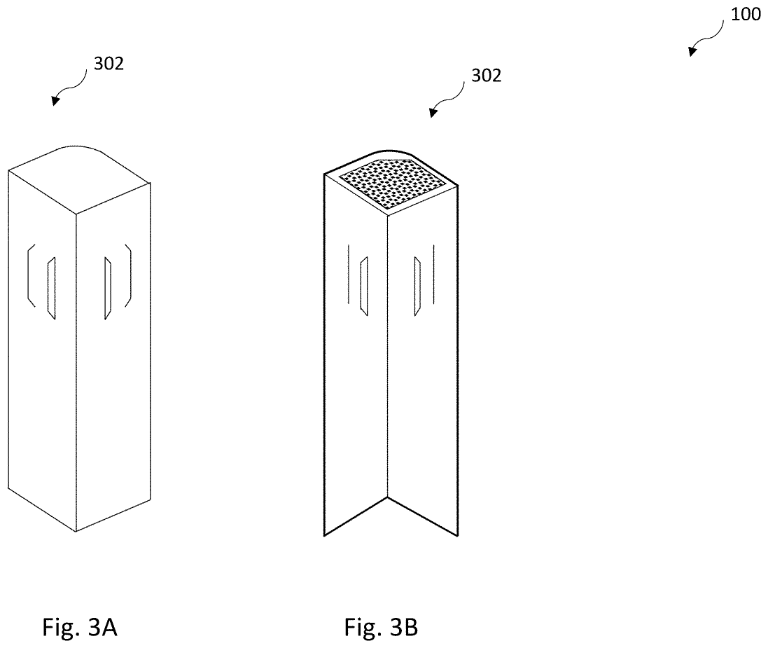

In some embodiments, edge protectors may be used on its own without any straps. FIG. 3A is a schematic perspective view of an edge protector 302 according to embodiments of the present disclosure. FIG. 3B is a perspective view of the edge protector 302 according to embodiments of the present disclosure. The edge protector 302 are similar to the edge protector 102 except that no straps are attached to the edge protector 302. For example, the edge protector 302 may be used in alone or in combination with other wrapping device. For sample, the edge protector 302 may be put on the pallet load and used with traditional plastic wraps. In some embodiments, the edge protector 302 does not include any strap retainers. In other embodiments, the edge protector 302 include strap retainers.

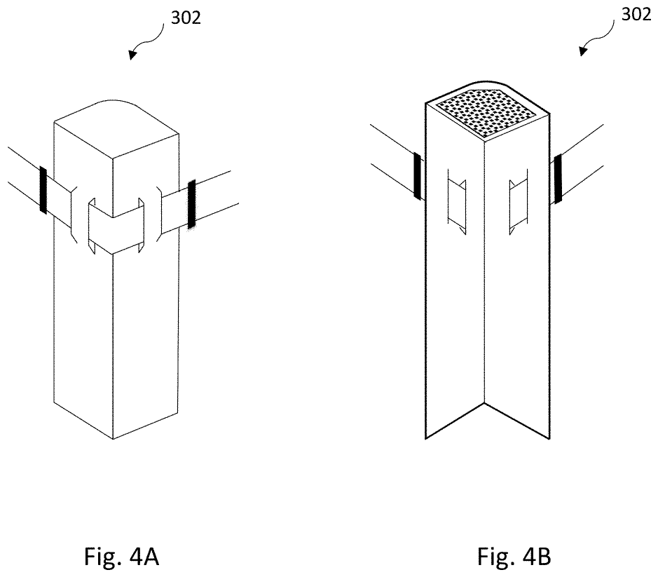

Individual edge protectors 302 and the straps 104 can be assembled together to form different wrapping devices. FIG. 4A-4B are schematic partial perspective views of the wrapping device 302 according to one embodiment of the present disclosure with a strap threaded therethrough.

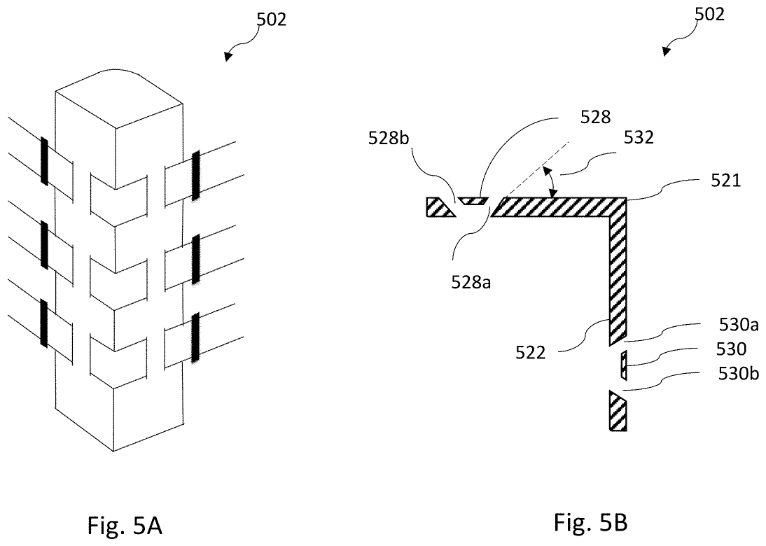

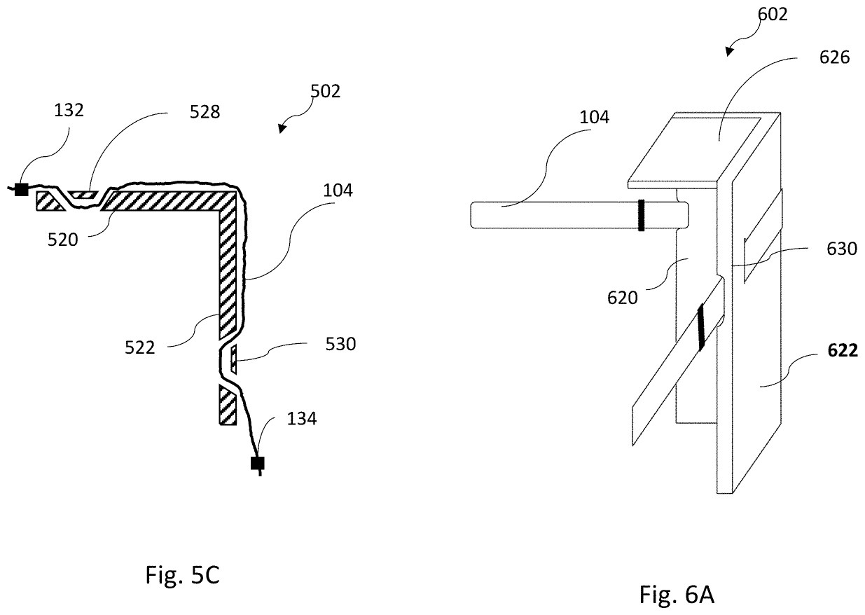

FIG. 5A is a schematic partial perspective view of an edge protector 502 to use in a wrapping device according to one embodiment of the present disclosure. FIG. 5B is a schematic partial sectional view of the edge protector 502 shown in FIG. 5A. FIG. 5C is a schematic partial sectional view of the edge protector 502 with the strap 104 threaded therethrough.

The edge protector 502 may be used in place of the edge protector 102 and 302 described above. The edge protector 502 is similar to the edge protector 102 except that the edge protector 502 includes strap retainers 528, 530 that are not protruding from edge panels 520, 522. The design of the edge protector 502 allows easy manufacturing process. Each strap retainer 528, 530 may be formed by cutting slots 528a, 528b and slots 530a, 530b on the edge panels 520, 522 respectively. The slots 528a, 528b and slots 530a, 530b may be parallel to an edge 521 that joint the edge panels 520, 522. In some embodiments, the slots 528a, 528b and slots 530a, 530b may be formed along an angle 532 relative to the edge panels 520, 522 along a thickness of the edge panels 520, 522. The angle 532 is formed to allow easy threading of the strap 104 and reduce friction to ease sliding between the strap 104 and the panels 520, 522. In some embodiments, the angle 532 is in an arrange between 30 degrees to 60 degrees.

In some embodiments, a portion of thickness of may be removed from the strap retainer portion 528, 530 to provide room for the strap 104 when the edge panel 520, 522 are secured against a pallet load.

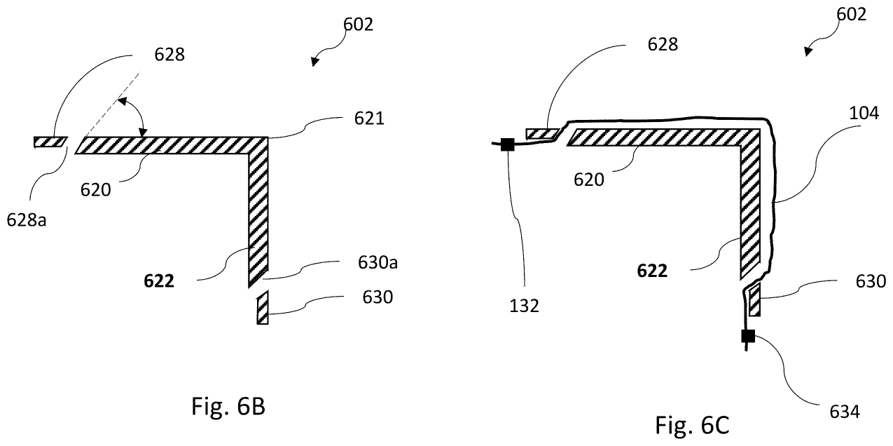

FIG. 6A is a schematic partial perspective view of an edge protector 602 to use in a wrapping device according to one embodiment of the present disclosure. FIG. 6B is a schematic partial sectional view of the edge protector 602 shown in FIG. 6A. FIG. 6C is a schematic partial sectional view of the edge protector 602 with the strap 104 threaded therethrough. The edge protector 602 may be used in place of the edge protector 102, 302, and 502 described above. The edge protector 502 is similar to the edge protector 602 except that the edge protector 602 includes strap retainers 628, 630 by cutting one slot in edge panels 620, 622.

The design of the edge protector 602 allows easy manufacturing process and also allows the strap 104 to lay flat on the pallet load. Each strap retainer 628, 630 may be formed by cutting a slot 628a and a slot 630a near an outer edge of the edge panels 620, 622 respectively. The slots 628a, 630b may be parallel to an edge 621 that joint the edge panels 620, 622. In some embodiments, the slots 628a, 630a, may be formed along an angle 632 relative to the edge panels 620, 622 along a thickness of the edge panels 620, 622. The angle 632 is formed to allow easy threading of the strap 104 and reduce friction to ease sliding between the strap 104 and the panels 620, 622. In some embodiments, the angle 632 is in an arrange between 20 degrees to 30 degrees.

In some embodiments, a portion of thickness of may be removed from the strap retainer portion 628, 630 to provide room for the strap 104 when the edge panel 620, 622 are secured against a pallet load.

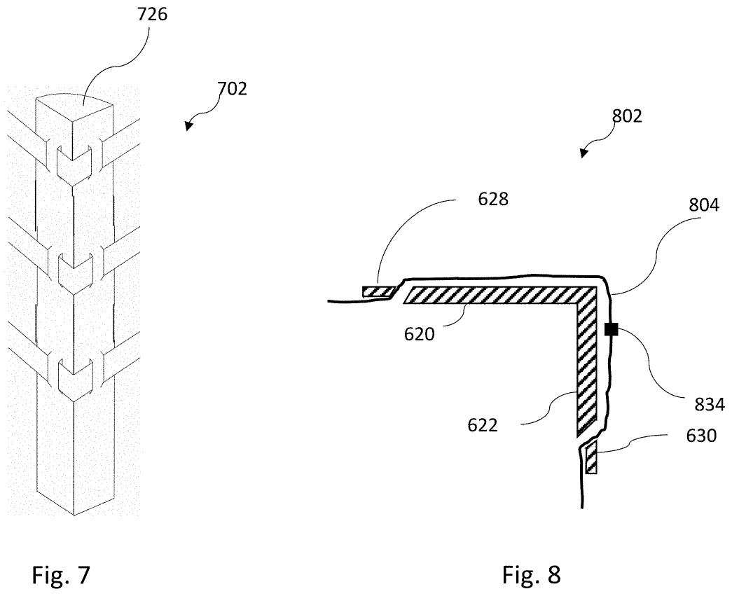

FIG. 7 is a schematic partial perspective view of an edge protector 702 according to one embodiment of the present disclosure. The edge protector 702 may be used in place of the edge protector 102, 302, 502, and 602 described above. The edge protector 702 is similar to the edge protector 102 except that the edge protector 702 includes a fan shaped end panel 726.

FIG. 8 is a schematic partial sectional view of an edge protector 802 according to one embodiment of the present disclosure. The edge protector 802 may be used in place of the edge protector 102, 302, 502, 602, and 702 described above. The edge protector 802 is similar to the edge protector 602 except that the edge protector 802 includes a strap 804 having a single stopper 834 positioned on the strap 804 between the strap retainers 628, 630. Using one stopper 834 between the strap retainers 628, 630 reduces complexity of the edge protector 802 and reduces costs of ownership. The strap 804 may be used with other edge protectors 102, 302, and 502 described above.

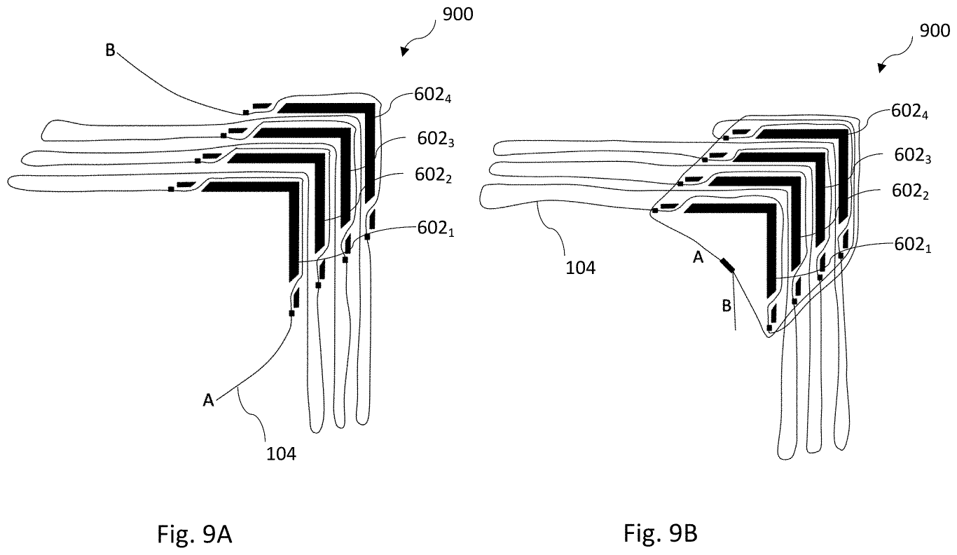

FIGS. 9A and 9B are schematic sectional view of a wrapping device 900 to illustrate a method for storing the wrapping device 900 according to one embodiment of the present disclosure. The wrapping device 900 includes corner protectors 602₁, 602₂, 602₃, 602₄ sequentially threaded along the strap 104. As shown in FIG. 9A, when not in use, the wrapping device 900 can be stored by stacking the second corner protector 602₂ over the first corner protector 602₁ while keeping the section of the strap 104 between the corner protectors 602₂, 602₁ between in the inner side of the corner protector 602₂ and the outer side of the corner protector 602₁. Similarly, the third corner protector 602₃ is stacked over the second corner protector 602₃ and the fourth corner protector 602₄ stacked over the third corner protector 602₄. After the corner protectors 602₁, 602₂, 602₃, 602₄ are stacked, two ends A and B of the strap 104 are on opposite sides of the stack.

The folding process can be performed while unpacking the pallet, as an operator walking around the pallet to remove the corner protectors 602₁, 602₂, 602₃, 602₄ one by one.

As shown in FIG. 9B, the stack can be secured by wrapping the strap 104 around the stack and then secure two ends A and B together using the fastening mechanism on the two ends A and B. After the two ends A and B of the strap 104 are secured together, the stack will stay stacked for storage or transportation. The method allows the wrapping device 900 to be neatly stored, thus saving storage space and avoiding entanglement. Similarly, wrapping devices, such as the wrapping device 100, may be stored similarly when not in use.

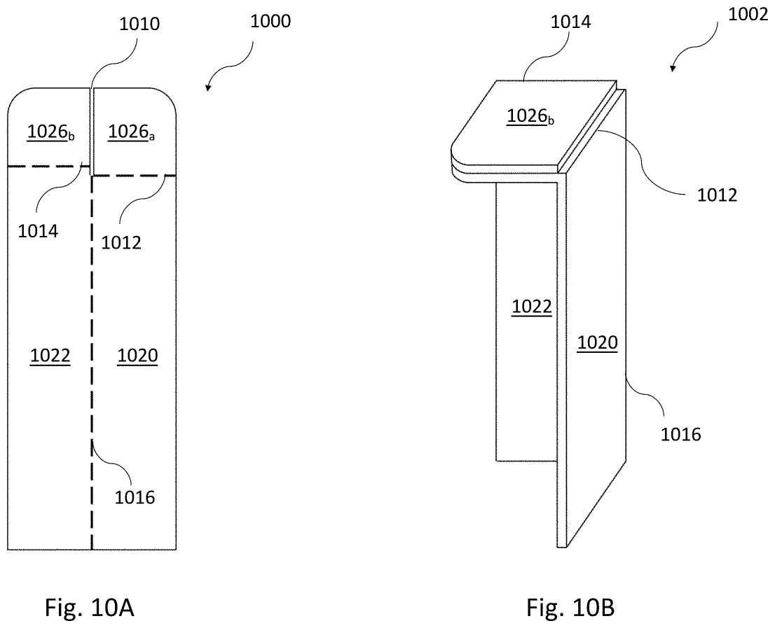

Corner protectors according to embodiments of the present disclosure may be made by various methods, for example, by compression molding, folding, or any suitable manufacturing methods. FIGS. 10A and 10B schematically illustrate a method for forming a corner protector 1002 according to one embodiment of the present disclosure. The corner protector 1002 may be formed from a plate 1000. The plate 1000 may be made of cardboard, plastic material, metal, or any suitable material. A slit 1010 is formed partially through a length of the plate 1000. The slit 1010 separates the upper portion of the plate 1000 to two tabs 1026a, 1026b. To form the corner protector 1002, the tab 1026a is valley folded along the line 1012. The plate 1000 is then valley folded along the line 1016 vertically extended from the slit 1010. The tab 1026b is then valley folded over the tab 1026a to form the corner protector 1002 as shown in FIG. 10B. In some embodiments, the tabs 1026a, 1026b may be secured together by adhesive, staples, or equivalents.

Wrapping devices according to embodiments of the present disclosure work well when loads on the pallets are large and regular. When a load includes small and/or irregular packages, one or more removable inserts may be used with the wrapping devices to further secure small or irregular packages in the load.

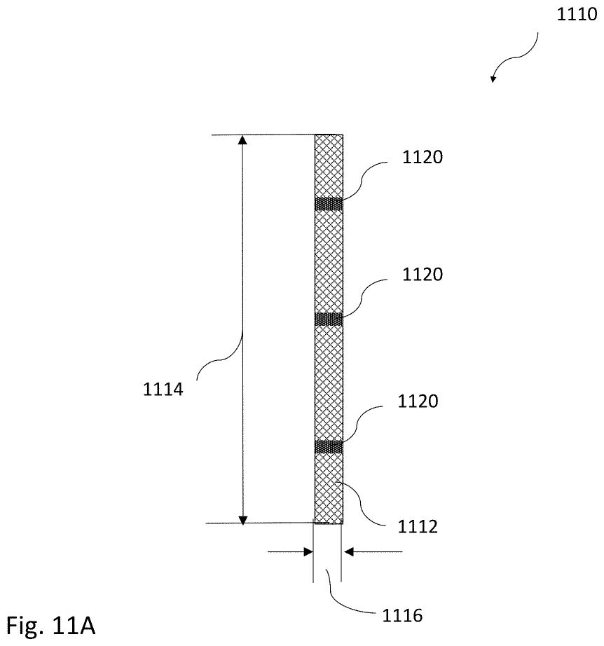

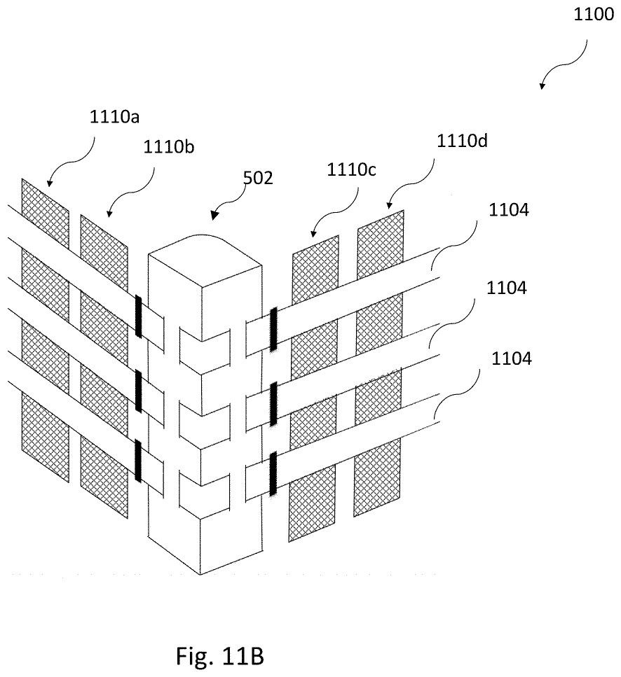

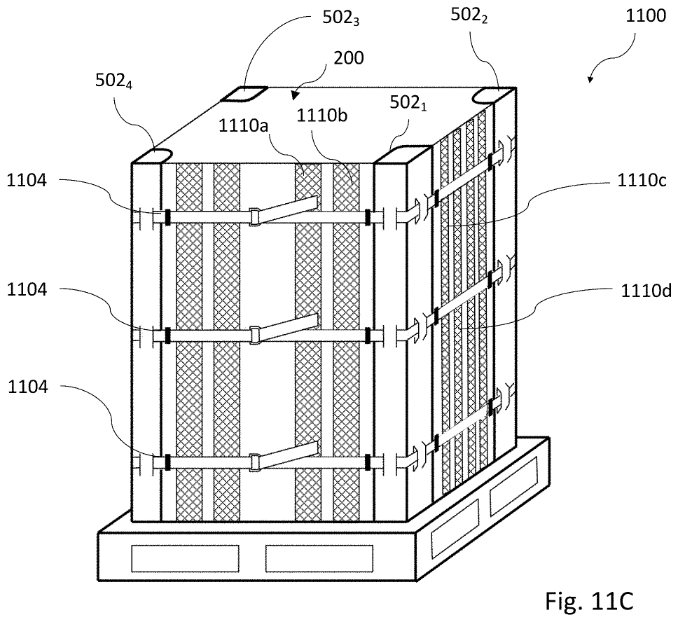

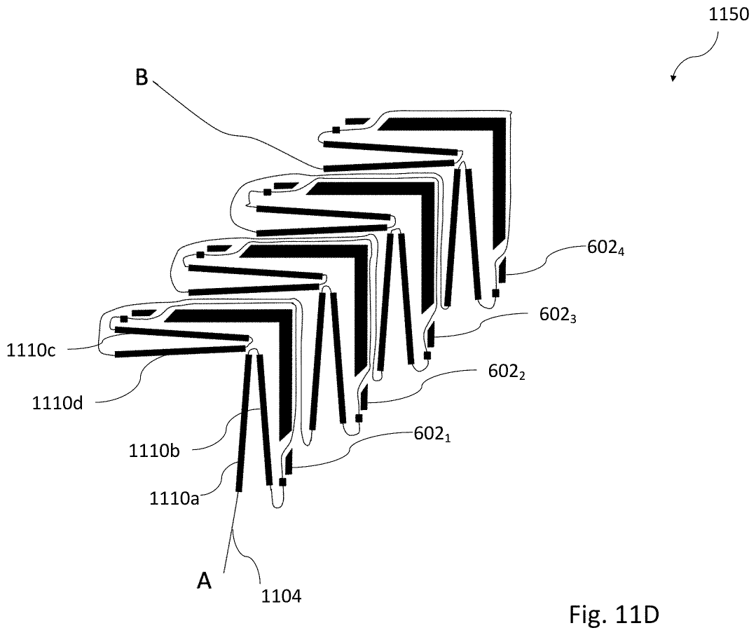

FIG. 11A schematically illustrates a removable insert 1110 for use with wrapping devices according to embodiments of the present disclosure. The removable insert 1100 is configured to use with wrapping devices with corner protectors, such as the wrapping devices 100 described above, to prevent small packages from falling out. The removable insert 1100 may include a panel 1112. The panel 1112 may be a rectangular panel having a height 1114 and a width 1116. The rectangular panel 1112 may be made a suitable packaging material with some rigidity to restrain packages in a pallet. In some embodiments, the panel 1112 is made of cardboard, such as paper cardboard and plastic cardboard, rubber, plastic, polymer, fabric, or a combination thereof.

In some embodiments, the removable insert 1110 includes one or more connecter 1120 configured to be removably attached to the strap between the edge protectors in a wrapping device. In some embodiments, locations of the connecters 1120 are aligned with locations of strap retainers, such as the strap retainers 128 in the edge protector 102. In one embodiment, the connector 1120 is part of a hook-and-loop fastener. For example, the connector 1120 is a portion of hook for a hook-and-loop fastener to work with straps having a portion of loop for a hook-and-loop fastener. Alternatively, the connector 1120 is a portion of loop for a hook-and-loop fastener to work with straps having a portion of hook for a hook-and-loop fastener. Other types of connectors, such as buttons, snaps, clips, adhesives, or any suitable connecting mechanism may be used in place of the hook-and-loop fasteners.

The height 1114 of the panel 1112 is selected to provide adequate support of the pallet load. In some embodiments, the panel 1112 is sized according to the size of the corner protectors in the wrapping device. Particularly, the height 1114 of the panel 1112 is similar to the height of edge panels of the corner protector, such as the edge panels 120, 122 in the corner protector 102, to provide adequate support to the pallet load. In some embodiment, the width 1116 of the panel 1112 is narrower than the height of edge panels of the corner protector, such as the edge panels 120, 122 in the corner protector 102, so that the panel 1112 can be stored between the edge protectors 102 while not in use. In some embodiments, two or more removable inserts 1110 may be used to cover open the spacing on the pallet between neighboring corner protectors during operation.

FIG. 11B is a partial schematic view of a wrapping device 1100 having removable inserts 1110 according to embodiments of the present disclosure. The wrapping device 1110 includes straps 1104 threaded through the corner protectors 502. The wrapping device 1100 is similar to the wrapping device 100 except that the wrapping device 1100 includes removable inserts 1110 adjacent to at least one of the corner protectors 502. In the embodiment shown in FIG. 1B, the wrapping device 1100 includes four removable 1110 adjacent each of the corner protectors 502. The straps 1104 is similar to the straps 104 except that the straps 1104 is adapted to connect with the removable inserts 1110. In some embodiments, an inner side of the strap 1104 include a portion of loop or hook to connect with the removable inserts 1110 through the connectors 1120. In some embodiments, the entire strap 1104 is covered by a loop portion or a hook portion of the hook-and-loop fasteners so that the removable inserts 1110 can be attached to any location on the straps 1104.

In the embodiments shown in FIG. 11B, four removable inserts 1110a, 1110b, 1110c, 1110d are used adjacent each of the corner protectors 1104 two or each side. Alternatively, any suitable number of removable inserts 1110 may be used with a wrapping device according to embodiments of the present disclosure. In some embodiments, the removable inserts 1110 may be used non-symmetrically or used with some edge protectors, not all edge protectors.

FIG. 11C is a schematic view of the pallet load 200 secured with the wrapping device 1100 with removable inserts 1110 according to embodiments of the present disclosure. The removable inserts 1110 are positioned against sides of the pallet load 200 to secure contents of the pallet load 200.

FIG. 11D is a schematic sectional view of a wrapping device 1150 with removable inserts 1110 showing a method of storing the wrapping device 1150. The wrapping device 1150 is similar to the wrapping device 1110 except that the corner protectors 602₁, 602₂, 602₃, 602₄ are used in place of the edge protectors 502.

The wrapping device 1150 includes corner protectors 602₁, 602₂, 602₃, 602₄ sequentially threaded along the strap 1104. As shown in FIG. 11D, when not in use, the wrapping device 1150 can be stored by first folding the removable inserts 1110a, 1110b, 1110c, 1110d inside the first corner protector first corner protector 602₁, two removable inserts 1110a, 1110b, and 1110c, 1110d each folded and placed against the edge panel of the first corner protector 602₁ Similarly, removable inserts 1110 adjacent the second corner protector 602₂ are folded in the second corner protector 602₂ in similar manner. Next, the second corner protector 602₂ is stacked over the first corner protector 602₁ while keeping the removable inserts 1110 inside each edge protectors, and keeping the section of the strap 1104 between the corner protectors 602₂, 602₁ between in the inner side of the corner protector 602₂ and the outer side of the corner protector 602₁.

Similarly, the removable inserts 1110 adjacent the third corner protector 602₃ is folded inside and third corner protector 602₃ is stacked over the second corner protector 602₃. The fourth corner protector 602₄ stacked over the third corner protector 602₄. After the corner protectors 602₁, 602₂, 602₃, 602₄ are stacked, two ends A and B of the strap 104 are on opposite sides of the stack.

The folding process can be performed while unpacking the pallet, as an operator walking around the pallet to remove the corner protectors 602₁, 602₂, 602₃, 602₄ one by one.

Embodiments of the present disclosure provide a reusable wrapping device for securing loaded goods on a transportation carrier, such as a pallet. The improved wrapping device allows an operator to secure the loaded goods on the pallet with edge protectors and straps threaded through the edge protectors. The edge protectors according to the present disclosure also include an end plane allowing the edge protector to rest on a pallet load without external force, thus, enabling easy application by one operator.

One or more embodiments provide a wrapping device. The wrapping device includes one or more edge protector, wherein each edge protector comprises two edge panels joined by one edge, and a strap slidingly attached to the one or more edge protector, wherein each edge panel includes strap retainer to receive the strap therethrough.

In one or more embodiments, each edge protector further comprises an end panel connected to the two edge panels at one end.

In one or more embodiments, the end panel includes a high friction region on an inner surface.

In one or more embodiments, each edge protector further comprises a sandpaper attached to an inner surface of the end panel.

In one or more embodiments, the strap retainer is formed by cutting one or two slots through the edge panel.

In one or more embodiments, the slots are formed at an angle relative to a top surface of the edge panel.

In one or more embodiments, the wrapping device further includes one or more stopper attached to the strap configured to limit a range of movement between the strap and the edge panel.

Some embodiments of the present disclosure provide a wrapping device. The wrapping device includes a first edge panel, a second edge panel, wherein the first edge and the second edge panel are joined together along one edge, and an end panel connected to the first and second edge panels at one end, wherein the first edge panel and second edge panel form a corner.

In one or more embodiments, the wrapping device further includes a strap slidingly attached to the first edge panel and the second edge panel through strap retainers formed the first and second edge panels respectively.

In one or more embodiments, the strap retainers are formed by forming a slot through the first and second edge panels near an outer edge.

In one or more embodiments, the strap retainers are formed by cutting parallel slots through the first and second edge panels.

In one or more embodiments, the strap retainers have a reduced thickness than the first and second edge panels.

In one or more embodiments, the wrapping device further includes a stopper attached to the strap to limit a range of motion of the strap relative to the first and second edge panels.

In one or more embodiments, the stopper is positioned between the strap retainers on the first and second edge panels.

In one or more embodiments, the wrapping device further includes a friction pad attached on an inner surface of the end panel.

Some embodiments of the present disclosure provide a wrapping device for securing a pallet load. The wrapping device includes four edge protectors, wherein each edge protector includes a first edge panel, a second edge panel, wherein the first edge and the second edge panel are joined together along one edge, and an end panel connected to the first and second edge panels at one end, wherein the first edge panel and second edge panel form a corner, and one or more straps slidingly connected to the four edge protectors.

In one or more embodiments, the end panel includes a high friction region on an inner surface.

In one or more embodiments, the wrapping device further includes one stopper disposed on the strap near each of the edge protector.

In one or more embodiments, each of the first and second edge panels includes one or more strap retainer to allow the strap passing through.

In one or more embodiments, the strap retainer includes a slot formed through a corresponding edge panel near an outer edge of the edge panel.

In one or more embodiments, the wrapping device further includes one or more inserts removably attached to the one or more straps.

In one or more embodiments, the insert comprises a panel, and one or more connectors positioned on the panel adapted to removably connect to the one or more straps.

Some embodiments of the present disclosure provide a method of storing a wrapping device. The method includes sequentially stacking corner protectors, wherein the corner protectors are threaded through one or more straps, and securing the stacked protectors using the one or more straps.

In one or more embodiments, the method further includes folding one or more removable inserts attached to the one or more straps inside adjacent corner protectors prior to stacking the corner protectors.

While the foregoing is directed to implementations of the present disclosure, other and further implementation of the disclosure may be devised without departing from the basic scope thereof, and the scope thereof is determined by the claims that follow.

1. A wrapping device, comprising:
one or more edge protector, wherein each edge protector comprises two edge panels joined by one edge; and
a strap slidingly attached to the one or more edge protector, wherein each edge panel includes strap retainer to receive the strap therethrough.

2. The wrapping device of claim 1, wherein each edge protector further comprises an end panel connected to the two edge panels at one end.

3. The wrapping device of claim 2, wherein the end panel includes a high friction region on an inner surface.

4. The wrapping device of claim 2, wherein each edge protector further comprises a sandpaper attached to an inner surface of the end panel.

5. The wrapping device of claim 1, wherein the strap retainer is formed by cutting one or two slots through the edge panel.

6. The wrapping device of claim 5, wherein the slots are formed at an angle relative to a top surface of the edge panel.

7. The wrapping device of claim 1, further comprising one or more stopper attached to the strap configured to limit a range of movement between the strap and the edge panel.

8. A wrapping device, comprising:
a first edge panel;
a second edge panel, wherein the first edge and the second edge panel are joined together along one edge; and
an end panel connected to the first and second edge panels at one end, wherein the first edge panel and second edge panel form a corner.

9. The wrapping device of claim 8, further comprising a strap slidingly attached to the first edge panel and the second edge panel through strap retainers formed the first and second edge panels respectively.

10. The wrapping device of claim 9, wherein the strap retainers are formed by forming a slot through the first and second edge panels near an outer edge.

11. The wrapping device of claim 9, wherein the strap retainers are formed by cutting parallel slots through the first and second edge panels.

12. The wrapping device of claim 10, wherein the strap retainers have a reduced thickness than the first and second edge panels.

13. The wrapping device of claim 9, further comprising a stopper attached to the strap to limit a range of motion of the strap relative to the first and second edge panels.

14. The wrapping device of claim 13, wherein the stopper is positioned between the strap retainers on the first and second edge panels.

15. The wrapping device of claim 8, further comprising a friction pad attached on an inner surface of the end panel.

16. A wrapping device for securing a pallet load, comprising:
four edge protectors, wherein each edge protector includes:
a first edge panel;
a second edge panel, wherein the first edge and the second edge panel are joined together along one edge; and
an end panel connected to the first and second edge panels at one end, wherein the first edge panel and second edge panel form a corner; and
one or more straps slidingly connected to the four edge protectors.

17. The wrapping device of claim 16, wherein the end panel includes a high friction region on an inner surface.

18. The wrapping device of claim 16, further comprising one stopper disposed on the strap near each of the edge protector.

19. The wrapping device of claim 16, wherein each of the first and second edge panels includes one or more strap retainer to allow the strap passing through.

20. The wrapping device of claim 19, wherein the strap retainer includes a slot formed through a corresponding edge panel near an outer edge of the edge panel.
